(19) United States
(12) Patent Application Publication
(10) Pub. No.: US 2008/0070675 A1
(43) Pub. Date: Mar. 20, 2008

(54) Method and Apparatus for Serverless Storage of Information

(76) Inventor: Mark B. Gagner, West Chicago, IL (US)

Correspondence Address: SCHWEGMAN, LUNDBERG & WOESSNER, P.A., P.O. BOX 2938, MINNEAPOLIS, MN, 55402, US

(21) Appl. No.: 11/576,387

(22) PCT Filed: Sep. 20, 2005
(86) PCT No.: PCT/US05/33536

§ 371 Date: Mar. 30, 2007

Related U.S. Application Data
(60) Provisional application No. 60/615,282, filed on Oct. 1, 2004.

(51) Int. Cl. G06F 17/00

(52) U.S. Cl. 463/25; 463/42; 463/43

(57) ABSTRACT

Methods and apparatus for serverless storage of information are described herein. In one embodiment, the method includes performing operations in a first gaming machine of a plurality of gaming machines of a serverless gaming network, the performing including receiving an identifier associated with a set of non-monetary player information. In the embodiment, the method also includes determining that the set is not stored on the gaming machine and requesting the set from at least one other gaming machine of the plurality of gaming machines. In the embodiment, the method also includes receiving the set and storing the set in the first gaming machine.

### RELATED APPLICATION

This application claims the priority benefit of U.S. Provisional Application Ser. No. 60/615,282 filed Oct. 1, 2004, the contents of which are incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention relates generally to the field of wagering game machines and more particularly to methods for storing player information in a wagering game machine.

### BACKGROUND

Gaming machines, such as slot machines, video poker machines, and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and increase profitability for the operator. In the competitive gaming machine industry, there is a continuing need for gaming machine manufacturers to produce new types of games, or enhancements to existing games, which will attract frequent play by enhancing the entertainment value and excitement associated with the game.

One concept that has successfully enhanced the entertainment value of a game is that of a “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Another concept that has been employed is a progressive jackpot. In the gaming industry, a “progressive” involves collecting coin-in data from participating gaming device(s) (e.g., slot machines), contributing a percentage of that coin-in data to a jackpot amount, and awarding that jackpot amount to a player upon the occurrence of a certain jackpot-won event. The percentage of the coin-in is determined prior to any result being achieved and is independent of any result. A jackpot-won event typically occurs when a “progressive winning position” is achieved at a participating gaming device. If the gaming device is a slot machine, a progressive winning position may, for example, correspond to alignment of progressive jackpot reel symbols along a certain payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement.

In current basic games, bonus games, and progressive games, the player is provided with little incentive to return to the game at a later time. Once the player chooses to stop playing the game, the player is immediately awarded any credits that are remaining and also loses assets that have been accumulated, but not yet awarded. For example, in some games, the bonus game consists of the player collecting assets and when a certain number or combination of non-monetary assets is accumulated, the player wins a monetary award. However, should the player choose to leave the game prior to winning the award, the player loses all of the assets accumulated. This can cause player frustration and does not provide the player with any incentive to return to the game.

Such a system also encourages “vulturing,” in which the “vulturing” player waits for a person who is close to winning an award to leave the gaming machine prior to the winning of the award. The “vulturing” player then begins to play the machine, and may quickly win the award without investing much time into the game. This is also frustrating for other players.

Conventional gaming systems typically store player information (e.g. player tracking information, player preferences, casino preferences) on a central server. When players initiate gaming sessions on the system, gaming machines request the player information from the central server, which typically fetches and delivers the player information. Such complex systems are typically maintained by highly trained professionals and protected by stringent security procedures. This leads to high operational costs that are not acceptable for small to medium sized gaming operators. Additionally, there can be high transmission latencies associated with fetching player information from a central server.

### SUMMARY

Methods and apparatus for serverless storage of information are described herein. In one embodiment, the method includes performing operations in a first gaming machine of a plurality of gaming machines of a serverless gaming network, the performing including receiving an identifier associated with a set of non-monetary player information. The method also includes determining that the set is not stored on the gaming machine and requesting the set from at least one other gaming machine of the plurality of gaming machines. The method also includes receiving the set and storing the set in the first gaming machine.

In one embodiment, the apparatus includes a memory unit to store a set of non-monetary player information associated with an identifier. The apparatus also includes a gaming processor to receive the identifier associated with the set, to determine that the set is not stored in the memory unit, to request the set from at least one other gaming machine of a plurality of serverless network gaming machines, to receive the set, to modify the set, and to store the set in the memory unit.

### BRIEF DESCRIPTION OF THE FIGURES

The present invention is illustrated by way of example and not limitation in the Figures of the accompanying drawings in which:

FIG. 1 is a block diagram of an exemplary serverless gaming network, in accordance with an embodiment of the present invention;

FIG. 2 is a block diagram illustrating components of a gaming machine, used in conjunction with exemplary embodiments of the invention;

FIG. 3 is a flow diagram illustrating operations for storing and modifying non-monetary player information in a serverless gaming network, according to exemplary embodiments of the invention;

FIG. 4 is a flow diagram illustrating operations for delivering non-monetary player information to network nodes of a serverless gaming network, according to exemplary embodiments of the invention; and

FIG. 5 is a perspective view of a gaming machine used in conjunction with embodiments of the invention.

### DESCRIPTION OF THE EMBODIMENTS

Methods and apparatus for serverless storage of non-monetary player information are described herein. In the following description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Moreover, in this description, the phrase “exemplary embodiment” means that the embodiment being referred to serves as an example or illustration.

Herein, block diagrams illustrate exemplary embodiments of the invention. Also herein, flow diagrams illustrate operations of the exemplary embodiments of the invention. The operations of the flow diagrams will be described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Moreover, it should be understood that although the flow diagrams depict serial operations, certain embodiments could perform certain of those operations in parallel.

### Hardware and Operating Environment

This section provides an overview of the exemplary hardware and the operating environment in which embodiments of the invention can be practiced.

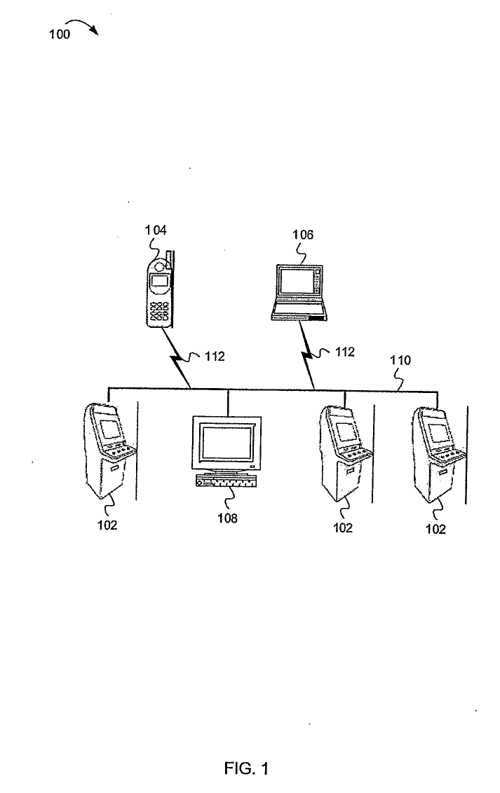

FIG. 1 is a block diagram of an exemplary serverless gaming network, in accordance with an embodiment of the present invention. As shown in FIG. 1, a serverless gaming network 100 includes a plurality of gaming machines 102, and a player information input terminal 108. These components of the serverless gaming network 100 can communicate over wired and/or wireless connections 110. The serverless gaming network 100 can also include one or more laptops 106 and/or hand-held computing devices 104 (e.g., personal digital assistants and cell phones). The laptops 106 and/or hand-held computing devices 104 can be connected to the serverless gaming network 100 using any suitable connection technology, such as Bluetooth, 802.11, Wireless Application Protocol (WAP), etc. The laptops 106 and hand-held computing devices 104 can be used for monitoring and/or configuring various system parameters, such as game session meters. The serverless gaming network 100 does not include a central server for controlling network components and storing non-monetary player information (e.g., non-monetary player asset information). In the discussion below, embodiments of gaming machines used in conjunction with serverless gaming networks will be described in greater detail.

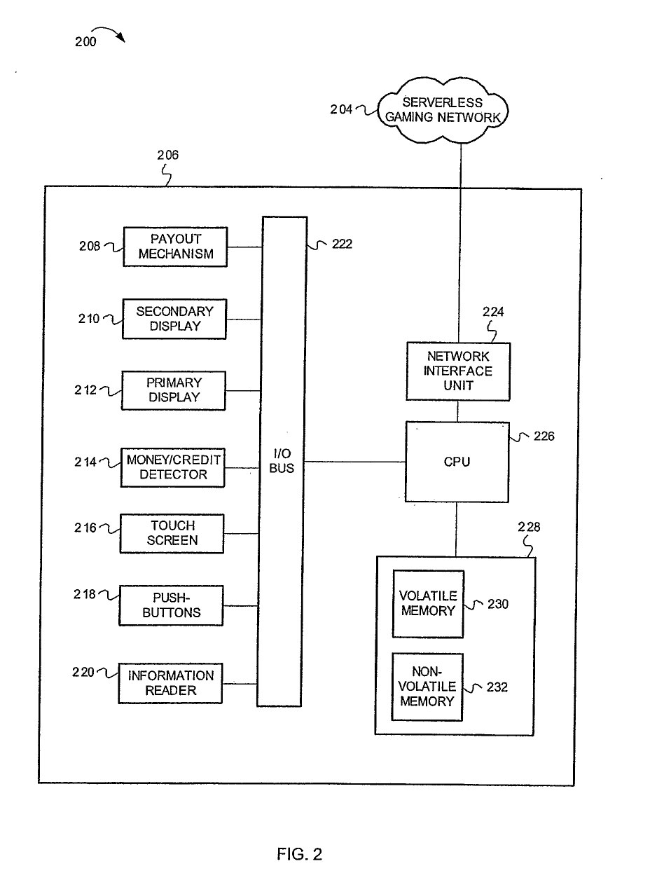

FIG. 2 is a block diagram illustrating components of a gaming machine, used in conjunction with exemplary embodiments of the invention. As shown in FIG. 2, the gaming machine 206 includes a CPU 226 connected to a memory unit 228, which includes a volatile memory 230 (e.g., random access memory) and a nonvolatile memory 232 (e.g., read only memory). The CPU 226 is also connected to a network interface unit 224, which is connected to a serverless gaming network 204. The CPU 226 is also connected to an input/output (I/O) bus 222. The I/O bus 222 is connected to a payout mechanism 208, secondary display 210, primary display 212, money/credit detector 214, touchscreen 216, post-buttons 218, and information reader 220. The I/O bus 222 facilitates communication between the system components and the CPU 226.

According to some embodiments, the gaming machine 206 can include additional peripheral devices and/or more than one of the components shown in FIG. 2. For example, in one embodiment, the gaming machine 206 can include multiple network interface units 224 and multiple CPUs 226. Additionally, the components of the gaming machine 206 can be interconnected according to any suitable interconnection architecture (e.g., directly connected, hypercube, etc.).

According to some embodiments, the gaming machine 206 includes machine-readable media including instructions for conducting a basic wagering game, conducting a bonus game, and storing and transmitting non-monetary player information in a serverless gaming network. Machine-readable media includes any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, electrical, optical, acoustical or other forms of propagated signals (e.g., carrier waves, infrared signals, digital signals, etc.). According to embodiments of the invention, the gaming machine 206 and other components of the serverless gaming network 100 can include other types of logic (e.g., digital logic) for executing the operations described herein.

According to embodiments, the gaining machine 206 can present any casino style wagering game, such as video poker, video blackjack, video slots, etc. In one embodiment, the wagering games can include a base game and a bonus game. When presenting the base game, the gaming machine 206 can present a plurality of symbols that indicate a randomly selected outcome, which is selected from a plurality of outcomes. For example, when presenting a video slots game, the gaming machine 206 can present a set of real symbols that indicates the game's outcome. Based on the outcome, the gaming machine 206 can provide monetary awards and non-monetary assets.

Non-monetary assets can represent any feature or element of a base game or bonus game. When the base and bonus games are based on a theme, the non-monetary assets can represent objects related to the theme. For example, for base and bonus games based on the Hasbro board game Monopoly™, non-monetary assets can represent elements of the board game, such as properties shown on the game board, houses, hotels, Chance cards, Community Chest cards, etc. As another example, for base and bonus games based on the Hollywood Squares™ television show, non-monetary assets can represent Xs or Os on a tic tac toe board.

According to embodiments, non-monetary assets can be used for initializing and conducting base and bonus games. For example, after a player accumulates a certain combination of non-monetary assets (referred to herein as an awarded set of non-monetary assets), the gaming machine 206 can present a bonus game based on the non-monetary assets. For example, the gaming machine 206 can initialize a Monopoly™ bonus game based on properties and houses a player “owns” (i.e., the player's non-monetary assets). In one embodiment, the non-monetary information set used for initializing the bonus game is referred to as a “bonus-starting” set.

In addition to awarding and tracking non-monetary assets, the gaming machine 206 can track and modify other non-monetary information, such as player tracking information, casino preferences, and player preferences. Non-monetary information can also include any other information relating to a base game or bonus game.

According to embodiments, player tracking information can include information about a player's playing habits. For example, the player tracking information can include dates and times games were played, money wagered, money won, money lost, gaming machines used, and other player information.

Casino preferences can include information for configuring certain aspects of a game. Casino preferences can include information about maximum wagers, minimum wagers, game duration, maximum losses allowed for a player, and other casino related information.

Player preferences can include information used for configuring certain aspects of a game. For example, player preferences can include background music, game color scheme, volume, bonus game preferences, etc.

The gaming machine 206 can track players and their non-monetary player information (including non-monetary assets) using tickets or vouchers. In one embodiment, the gaming machine 206 stores in a local persistent storage device (e.g., the gaming device's non-volatile memory 232) a set of non-monetary player information accumulated during a player gaming session. The gaming machine 206 also stores a unique identifier with the set of non-monetary player information. According to embodiments, when a player terminates a gaming session, the gaming device 206 prints a voucher baring the unique identifier. If the player uses the ticket to initiate another gaming session on a node (e.g., any gaming machine) on the serverless gaming system 100, the node will request and receive from the gaming machine 206 the set of non-monetary player information associated with the unique identifier.

As a result, the player will have access to any accumulated non-monetary player information including non-monetary assets. Operations for storing and modifying non-monetary player information are described below, in the next section.

In addition to using tickets for tracking non-monetary player information, embodiments of the serverless gaming system 100 can also use biometric devices, smart cards, magnetic cards, RF tags, and/or any other suitable player-tracking device. For embodiments that use player-tracking devices, the unique identifier associated with the player's non-monetary player information is stored in the player-tracking device. If the player presents the player tracking device bearing the unique identifier, the serverless gaming network will provide the non-monetary player tracking information associated with the unique identifier.

Operations performed by embodiments of the serverless gaming network are described below, in the next section.

### System Operations

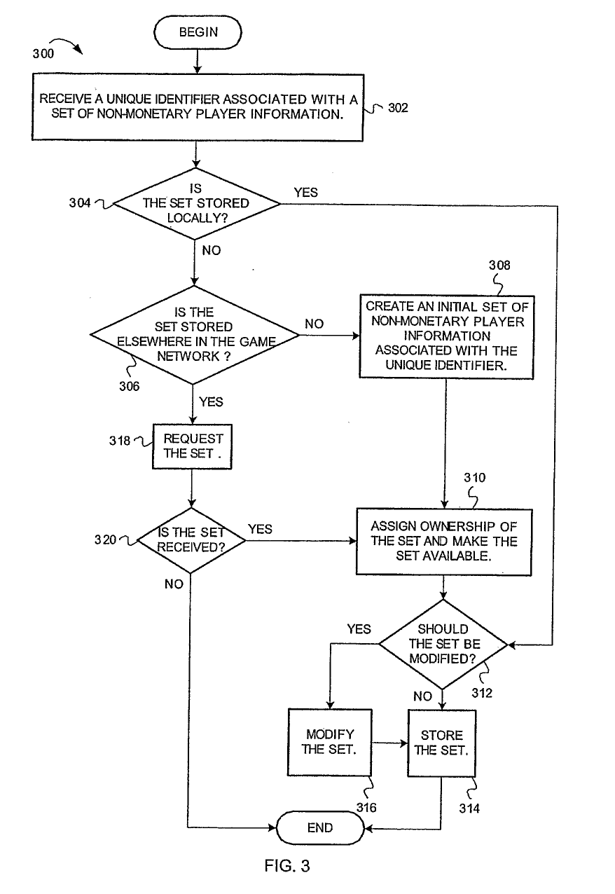

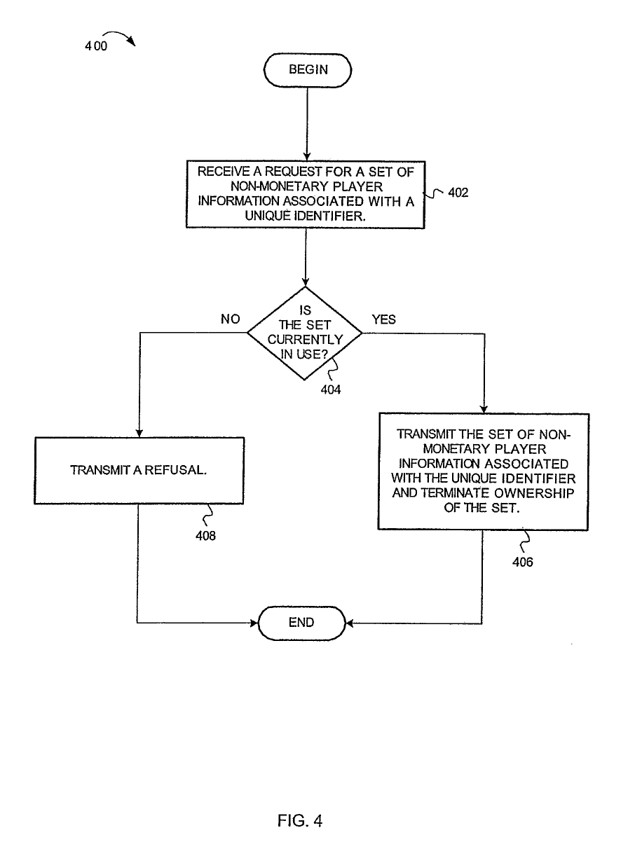

This section describes operations performed by embodiments of the gaming system described above. In this section, FIG. 3 describes operations for modifying and locally storing non-monetary player information in a serverless gaming network, while FIG. 4 describes delivering non-monetary player information to a remote gaming machine of the serverless gaming network.

FIG. 3 is a flow diagram illustrating operations for storing and modifying non-monetary player information in a serverless gaming network, according to exemplary embodiments of the invention. The operations of flow diagram 300 will be described with reference to the exemplary serverless gaming network of FIG. 1. The flow diagram 300 begins at block 302.

At block 302, a unique identifier is received, where the unique identifier is associated with a set of non-monetary player information. For example, the gaming machine 102 can receive a unique identifier when a player inserts a ticket into the information reader 220. Alternatively, the gaming machine 102 can receive the unique identifier from any suitable player tracking device. In one embodiment, the non-monetary player information set includes asset information, such as properties, houses, hotels, and other game pieces acquired during a Monopoly™ theme casino game. In one embodiment, the set of non-monetary player information can also include player preferences, casino preferences, player tracking information, and any other relevant player information. The flow continues at block 304.

At block 304, a determination is made about whether the non-monetary player information set is stored locally. For example, the gaming machine 102 determines whether the non-monetary player information set is stored in its own data store (e.g., the non-volatile memory 232). If the set is stored locally, the flow continues at block 312. Otherwise, the flow continues at block 306.

At block 306, a determination is made about whether the non-monetary player information set is stored elsewhere in the gaming system. For example, the gaming machine 102 determines whether the non-monetary player information set is stored on another network node (e.g., gaming machine 102 or player information input terminal 108) of the serverless gaming network 100. If the non-monetary player information set is stored elsewhere, the flow continues at block 318. Otherwise, flow continues at block 308.

At block 318, the set is requested. For example, the gaming machine 102 request the non-monetary player information set from other network nodes. The flow continues at block 320.

At block 320, a determination is made about whether the set has been received. For example, the gaming machine 102 determines whether it has received the set from another network node. In one embodiment, if the gaming machine 102 does not receive the set from another network node, the gaming machine 102 rejects the player-tracking device (e.g., a ticket) and indicates that an error has occurred. If the set has not been received, the flow ends. Otherwise, the flow continues at block 310.

At block 308, an initial set of non-monetary player information is created, where the set is associated with a unique identifier. For example, the gaming machine 102 creates an initial non-monetary player information set and associates the set with a unique identifier. The set can be empty or it can include default non-monetary player information. The flow continues at block 310.

At block 310, ownership of the set is assigned and the set is made available for use. For example, the gaming machine 102 assigns itself ownership of the set. When a network node, such as the gaming machine 102, owns a non-monetary player information set, it is responsible for responding to requests for the non-monetary player information set. After assigning ownership, the gaming machine 102 can make the non-monetary player information available for a player to use during a gaming session. The flow continues at block 312.

At block 312, a determination is made about whether the set should be modified. For example, the gaming machine 102 determines whether the set should be modified based on gaming results, player input, casino regulations, or other conditions or information that could cause the non-monetary player information to be modified. If the set should be modified, the flow continues at block 316. Otherwise, the flow continues at block 314.

At block 316, the non-monetary player information set is modified. For example, the gaming machine 102 can add, delete, or modify and the non-monetary player information contained in the set. In one embodiment, the gaming machine 102 can add, delete, and/or modify properties, houses, hotels, and other game pieces acquired during a Monopoly® theme casino game. The flow continues at block 314.

At block 314, the non-monetary player information set associated with the unique identifier is stored. For example, the gaming machine 102 stores the non-monetary player information set and the unique identifier in its non-volatile memory 232. In one embodiment, the storage method preserves an association between the non-monetary player information set and the unique identifier. From block 314, the flow ends.

While FIG. 3 describes operations for storing and modifying non-monetary player information, FIG. 4 describes operations for delivering non-monetary player information.

FIG. 4 is a flow diagram illustrating operations for delivering non-monetary player information to network nodes of a serverless gaming network, according to exemplary embodiments of the invention. The flow diagram 400 will be described with reference to the serverless gaming network of FIG. 1. The flow diagram 400 begins at block 402.

At block 402, a request is received, where the request is for a non-monetary player information set associated with a unique identifier. For example, a gaming machine 102 on the serverless gaming network 100 receives a request from another gaming machine 102, where the request is for a non-monetary player information set associated with a unique identifier. The flow continues at block 404.

At block 404, a determination is made about whether the set is currently in use. For example, the gaming machine 102 determines whether another node on the serverless gaming network 100 is currently using the set. If the set is currently in use, the flow continues at 408. Otherwise, the flow continues at block 406.

At block 406, the non-monetary player information set associated with the unique identifier is transmitted and ownership of the set is terminated. For example, the gaming machine 102 transmits the non-monetary player information set associated with a unique identifier to another network node of the serverless gaming network 100. After transmitting the set, the gaming machine 102 terminates ownership of the set. From block 404, the flow ends.

At block 408, a refusal is transmitted. For example the gaming machine 102 transmits a refusal to the requesting node. In one embodiment, the refusal indicates that the set is currently being used and the request is refused. From block 408, the flow ends.

### Exemplary Gaming Machine

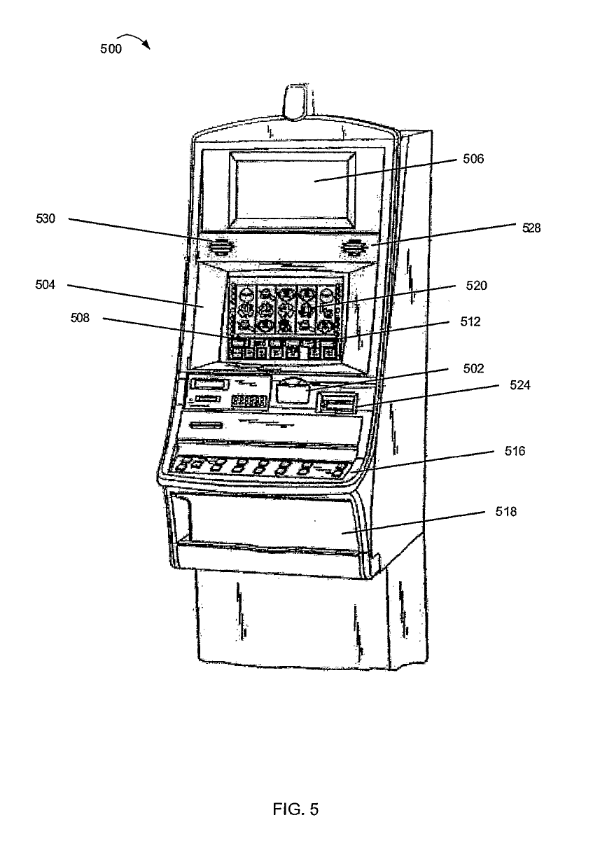

FIG. 5 is a perspective view of a gaming machine used in conjunction with embodiments of the invention. As shown in FIG. 5, the gaming machine 500 can be a slot machine having the controls, displays, and features of a conventional slot machine. The gaming machine 500 can be operated while players are standing or seated. Additionally, the gaming machine 500 is preferably mounted on a console. However, it should be appreciated that the gaming machine 500 can be constructed as a pub-style tabletop game (not shown), which a player can operate while sitting. Furthermore, the gaming machine 500 can be constructed with varying cabinet and display designs. The gaming machine 500 can incorporate any primary game such as slot, poker, or keno, and additional bonus round games. The symbols and indicia used on and in the gaming machine 500 can take mechanical, electrical or video form.

As illustrated in FIG. 5, the gaming machine 500 includes a coin slot 502 and bill acceptor 524. Players can place coins in the coin slot 502 and paper money or ticket vouchers in the bill acceptor 524. Other devices can be used for accepting payment. For example, credit/debit card readers/validators can be used for accepting payment. Additionally, the gaming machine 500 can perform electronic funds transfers and financial transfers to procure monies from house financial accounts. When a player inserts money in the gaming machine 500, a number of credits corresponding to the amount deposited are shown in a credit display. After depositing the appropriate amount of money, a player can begin playing the game by pushing play button 508. The play button 508 can be any play activator used by the player to start a game or sequence of events in the gaming machine 500.

As shown in FIG. 5, the gaming machine 500 also includes a bet display 512 and a “bet one” button 516. The player places a bet by pushing the bet one button 516. The player can increase the bet by one credit each time the player pushes the bet one button 516. When the player pushes the bet one button 516, the number of credits shown in the credit display 506 decreases by one, and the number of credits shown in the bet display 512 increases by one.

A player may “cash out” by pressing a cash out button. When a player cashes out, the gaming machine 500 dispenses a number of coins, corresponding to the number of remaining credits, into the coin tray 518. The gaming machine 500 may employ other payout mechanisms such as credit slips, which are redeemable by a cashier, or electronically recordable cards, which track player credits.

The gaming machine 500 also includes one or more display devices. The embodiment shown in FIG. 5 includes a primary display unit 504 and a secondary display unit 506. In one embodiment, the primary display unit 504 displays a plurality of reels 520. In one embodiment, the gaming machine displays three reels, while an alternative embodiment displays five reels. In one embodiment, the reels are in video form. According to embodiments of the invention, the display units can display any visual representation or exhibition, including moving physical objects (e.g., mechanical reels and wheels), dynamic lighting, and video images. In one embodiment, each reel 520 includes a plurality of symbols such as bells, hearts, fruits, numbers, letters, bars or other images, which correspond to a theme associated with the gaming machine 500. Furthermore, as shown in FIG. 5, the gaming machine 500 includes a primary sound unit 528 and a secondary sound unit 530. In one embodiment, the primary and secondary sound units include speakers or other suitable sound projection devices. The gaming machine 500 can be adapted to include the system 500. Additionally, the gaming machine 500 is capable of performing the operations for processing game settings described herein.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A method comprising:
performing operations in a first gaming machine of a plurality of gaming machines of a serverless gaming network, the performing including,
receiving an identifier associated with a set of non-monetary player information;
determining that the set is not stored on the gaming machine;
requesting the set from at least one other gaming machine of the plurality of gaming machines;
receiving the set; and
storing the set in the first gaming machine.

2. The method of claim 1, the performing further including, modifying the set.

3. The method of claim 1, the performing further including,
receiving a request for the set from a second gaming machine of the plurality of gaming machines of the serverless gaming network, wherein the second gaming machine has received the identifier; and
transmitting the set.

4. The method of claim 1, the performing further including,
determining that the set of non-monetary player information associated with the identifier does not exist; and
creating the set.

5. The method of claim 1, wherein the identifier is a player identifier or a ticket identifier.

6. The method of claim 1, wherein the set of non-monetary player information includes information selected from the group consisting of player tracking information, player preferences, casino preferences, and non-monetary game assets.

7. A method comprising:
performing operations in a first gaming machine of a plurality of gaming machines of a serverless gaming network, the performing including,
receiving an identifier associated with a set of non-monetary player information;
determining that the set is not stored on the gaming machine;
requesting the set from at least one other gaming machine of the plurality of gaming machines;
determining whether the set is received;
if the the set is received, storing the set in the first gaming machine; and
if the set is not received, rejecting the identifier.

8. The method of claim 7, wherein rejecting the identifier includes returning a ticket to a player of the first gaming machine.

9. The method of claim 7, wherein if the set is not received, a response indicating that the identifier is being used is received.

10. A method for presenting a wagering game, comprising:
presenting, in a first gaming machine, a basic game having a plurality of symbols that indicate a randomly selected outcome that has been selected from a plurality of outcomes in response to a wager input, wherein the plurality of outcomes includes awards of non-monetary assets, and wherein an awarded set of the non-monetary assets is accumulated by a player; and
presenting, in the first gaming machine, a bonus game, wherein the bonus game is initialized after the awarded set includes a bonus-starting set of at least one of the non-monetary assets; and
in response to termination of a gaming session of the player, storing the awarded set in the first gaming machine for use in a subsequent gaming session of the player, wherein the subsequent gaming session can be played on the first gaming machine or a second gaming machine.

11. The method of claim 10, further comprising:
after presenting the bonus game, removing the bonus-starting set from the awarded set.

12. The method of claim 10, wherein the wagering game is selected from the set consisting of video slots, video poker, video blackjack, and video roulette.

13. A gaming machine comprising:
a memory unit to store a set of non-monetary player information associated with an identifier; and
a gaming processor to receive the identifier associated with the set, to determine that the set is not stored in the memory unit, to request the set from at least one other gaming machine of a plurality of serverless network gaming machines, to receive the set, to modify the set, and to store the set in the memory unit.

14. The gaming machine of claim 13, wherein the gaming processor is further operative to modify the set.

15. The gaming machine of claim 13, wherein the gaming processor is further operative to receive a request for the set from a second gaming machine of the plurality of serverless network gaming machines, wherein the second gaming machine has received the identifier, and is further operative to transmit the set.

16. The gaming machine of claim 13, wherein the gaming processor is further operative to determine that the set of non-monetary player information associated with the identifier does not exist, and to create the set.

17. The gaming machine of claim 13, wherein the gaming processor is further operative to present a basic game and a bonus game.

18. A gaming system comprising:
a serverless network of gaming machines, wherein each of the gaming machines is to present at least one of a game set of wagering games, wherein one of the game set, when played, awards non-monetary assets to a player, wherein the player is to accumulate an awarded set of non-monetary assets, wherein the awarded set is to be stored on one of the gaming machines, wherein the player is to play one of the game set on a first of the gaming machines, and wherein the first of the gaming machines is to request and receive from a second of the gaming machines the awarded set.

19. The gaming system of claim 18, wherein the requesting is a broadcast over the serverless network of gaming machines.

20. The gaming system of claim 18, wherein the first of the gaming machines to modify the awarded set, wherein the first of the gaming machines to store the awarded set.

21. A serverless gaming system comprising:
a first gaming machine to perform operations including,
receiving an identifier associated with a set of non-monetary player information;
determining that the set is not stored on the gaming machine:
requesting the set;
receiving the set; and
storing the set in the first gaming machine; and
a second gaming machine to perform operations including,
receiving a request for the set from the first gaming machine; and
transmitting the set to the first gaming machine.

22. The serverless gaming system of claim 21, wherein the first gaming machine is further to perform operations including modifying the set.

23. The serverless gaming system of claim 21, further comprising a player information input terminal to create or modify the set.

24. The serverless gaming system of claim 21, wherein the identifier is associated with a ticket, and wherein the set can be retrieved for any player bearing the ticket.
